(19) United States
(12) Patent Application Publication
(10) Pub. No.: US 2012/0001412 A1
(43) Pub. Date: Jan. 5, 2012

(54) Surface Modified Optically Variable Product for Security Feature

(75) Inventor: Guruswamy Kumaraswamy, Pune (IN)

(73) Assignee: COUNCIL OF SCIENTIFIC & INDUSTRIAL RESEARCH, New Delhi (IN)

(21) Appl. No.: 13/139,492

(22) PCT Filed: Dec. 15, 2009
(86) PCT No.: PCT/IN09/00722

§ 371 Date: Sep. 20, 2011

(30) Foreign Application Priority Data
Dec. 15, 2008 (IN) 2827/DEL/2008

(51) Int. Cl. B42D 15/00; B41M 3/14

(52) U.S. Cl. 283/85; 427/7

(57) ABSTRACT

Surface modified optically variable product to provide security features in packaging materials and currency notes to prevent counterfeiting. Surface modified optically variable product is optionally readily functionalized to disperse them in organic and aqueous inks.

### FIELD OF THE INVENTION

Present invention relates to surface modified optically variable product to provide security features in packaging materials and currency notes to prevent counterfeiting.

Present invention also relates to surface modified optically variable product that is optionally readily functionalized to disperse them in organic and aqueous inks.

### BACKGROUND OF THE INVENTION

Security printing is a basic requirement of the printing industry for currency notes, stamps/stamp papers, secure packaging materials, passports, stock certificates, identity cards and such documents. The security printing features should be such that they help identify the genuine from the counterfeited documents by simple, easily implementable and user-friendly means. It should preferably be usable without the need for additional complex devices or instruments to detect counterfeiting, if any. Several options and recent technologies are available to introduce security features in printed products. Some of these include security paper, water marks, micro printing, security thread, magnetic inks and serial numbers. Colour changing inks or optically variable inks are another option available to incorporate security feature in such documents. These are essentially inks that change colour when viewed from different angles. Optically variable inks are very expensive inks and counterfeiters will require significant resources and effort to replicate its use. Most often original documents have more than one security feature incorporated in them to be an additional deterrent to counterfeiters. Nevertheless, more than $35 billion in pharmaceutical revenue and $40 billion in aircraft parts revenue is lost each year to counterfeiting.

References may be made to U.S. Pat. No. 5,171,363, wherein an optically variable printing ink for obtaining a color shift between two distinct colors at first and second angles of incident light, comprising a liquid ink vehicle and optically variable flakes disposed in the ink vehicle, the optically variable flakes being comprised of a multilayer thin film structure having first and second planar surfaces, the optically variable flakes having a physical thickness which is measured in a direction perpendicular to the layers of the thin film structure, the optically variable flakes having a maximum dimension ranging from approximately two to twenty microns used in anti-counterfeiting applications.

References may be made to patent application US2003/0116062, wherein pigments; especially interference pigments, characterized by a 3-D periodic arrangement of monodisperse spheres in the nanometer range and is mechanically stabilized by physical and chemical modification are mentioned. Monodisperse spheres comprise preferably silicon dioxide or polystyrene, and having a surface, which is modified, with at least one silane. In the case of silica spheres, preferably tetraethylorthosilicate is added to the suspension. It hydrolyses to silicon dioxide and leads to chemical bonding of the spheres to one another. To suspend the spheres in the liquid medium, it is preferable to add a compound, which is hydrolysable in water and whose hydrolysis product deposits on the spheres in the course of the formation of the opal structure and brings about chemical bonding of the spheres to one another.

The colour play of these opals comes out by Bragg-like scattering of the incident light at the lattice planes of the spherules, with their crystalline arrangement.

References may be made to U.S. Pat. No. 7,255,736 titled “Effect pigments based on thin SiO₂ flakes” relates to effect pigments having improved optical properties based on SiO₂ flakes coated with one or more layers, where the SiO₂ flakes have a layer thickness of from 50 nm to 150 nm, coated with only one layer of a metal oxide, metal oxide hydrate, metal suboxide or metal fluoride or only one layer of mixture thereof, process for the preparation thereof and use of these pigments in security printing, in security features in personal identity cards, bank notes, and for other counterfeiting-proof documents.

Thus it is clear from the existing art that security strips with one-dimensional periodic stack is used to achieve color shifting and there exists a clear and urgent need to look at additional means to provide a method for easy identification of counterfeiting.

Further there exists a need for the method of identification to be as simple as a visual means to facilitate the process of identification of counterfeiting.

### OBJECTIVE OF THE INVENTION

The main objective of the present invention is to provide surface modified optically variable security features in packaging materials and currency notes to prevent counterfeiting.

Another objective of the present invention is to provide surface modified optically variable product that is optionally readily functionalized to disperse them in organic and aqueous inks.

### SUMMARY OF THE INVENTION

Accordingly, the present invention provides surface modified optically variable product for detecting/preventing counterfeiting comprising a nanoparticle self assembly of a polymer or an inorganic material.

In an embodiment of the present invention, the polymer material is selected from the group consisting of polystyrene and polymethylmethacrylate and the inorganic material, is selected from the group consisting of silica and titania.

In another embodiment of the present invention, the size of the polymer or an inorganic material varies in the range of 50 to 2500 nm.

In still another embodiment of the present invention, the polymeric material is characterized by having functionalizable groups.

In a further embodiment of the present invention, is provided a process for the preparation of the said optically variable product useful in detection/prevention of counterfeiting comprising:
i. preparing a dispersion of the polymeric material or inorganic material of particle size 50 to 2500 nm;
ii. spraying the dispersion on a surface of controlled hydrophilicity to obtain a monolayer of spheres;
iii. drying the dispersion at room temperature to obtain the formation of close-packed iridescent layers of particles and determining the colour by the layer periodicity formed;
iv. annealing the particle layer just below the glass transition of polymeric material to sinter the spheres and to freeze the periodic layer structure;
v. separating the layer as obtained in step (iv) by sonicating the coated substrate in a bath to obtain the optically variable product, wherein the colour is structural in character;
vi. modifying the surface of the product by adsorption of polyelectrolyte and by chemical treatment to obtain optically variable product;
vii. dispersing the optically variable product in organic solvents and coating on security documents to aid in detection of counterfeiting of security documents.

In another embodiment of the present invention, the surface of controlled hydrophilicity is selected from flat substrate, more preferably mica.

In yet another embodiment of the present invention, the polyelectrolyte used is polyethylene imine to make the optically variable product hydrophobic.

In still another embodiment of the present invention, the aldehyde and organo silane are used for chemical treatment.

In yet another embodiment of the present invention, the aldehyde is selected from the group consisting of aliphatic aldehyde and aromatic aldehyde more preferably acetaldehyde and benzaldehyde.

In still another embodiment of the present invention, the organo silane used is preferably aminopropyltriethoxysilane.

In an embodiment of the present invention, the organic solvent is selected from the group consisting of hexane and toluene.

In another embodiment of the present invention, the said optically variable product is in the form of ink, which is preferably formulated in the security thread of security document.

In another embodiment of the present invention, the said optically variable product is tuned to get all the colors in the visible spectrum.

In still another embodiment of the present invention, the surface modified optically variable product counterfeiting is useful for detecting/preventing counterfeiting in security documents selected from currency notes, stamps, stamp papers, secure packaging materials, passports, stock certificates and identity cards.

### DESCRIPTION OF THE FIGURES

FIG. 1: Opalescent film of 300 nm silica particles formed by filtration. Orange colour opalescent colours can be clearly observed.

FIG. 2: Drying of 200 nm polystyrene latex film to form opalescent “flakes” that can be dispersed into an aqueous medium. Green opalescent colours can be clearly observed.

FIG. 3: Drying of 200 nm polystyrene latex film to form opalescent “flakes” that can be dispersed into an aqueous medium.

FIG. 4: Drying of 200 nm polystyrene latex film to form opalescent “flakes” that can be dispersed into an aqueous medium.

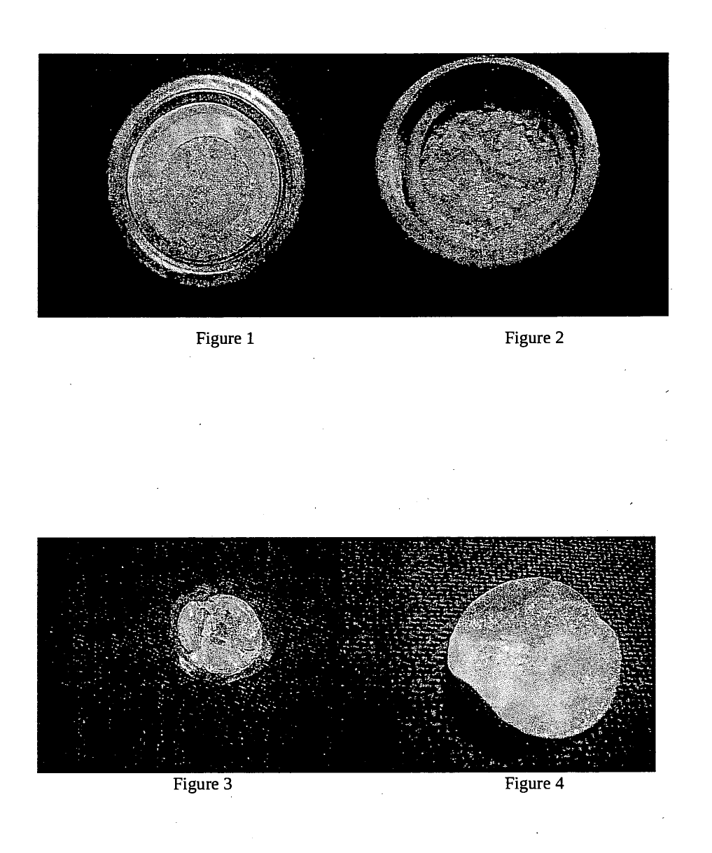

### DETAILED DESCRIPTION OF THE INVENTION

Present invention discloses an optically variable product for colour shifting or a product that shows different colors when viewed in different directions to prevent counterfeiting of packing materials, currency notes and such like. The optically variable product according to the present invention is optionally readily functionalized to disperse them in organic and aqueous inks. Further, the products are tuned to get all the colours in the visible spectrum by choosing the required particle size.

The invention further discloses optically variable products as nanoparticle self-assembly to give a 3-dimensional periodic array of spheres/materials to achieve refractive index modulation and Bragg-like reflectivity. Stop-band or the reflected wavelength is achieved by tuning the size of the spheres chosen. After formation of the periodic array, the spheres are sintered to retain their structural integrity and are surface functionalized to enable dispersion in a variety of matrices. For polymer spheres/arrays, this is done via layer-by-layer assembly, while for inorganic (for example: silica) sphere this is done via silane treatments. The inorganic spheres are stable at temperatures up to 250° C. The said nanoparticles self-assembly give a readily soluble 3-dimensional periodic array of the optically variable product to detect/identify/prevent counterfeiting.

Existing solutions for the problem of counterfeiting, for example, as used on the security strip of the INR 500 note rely on a one dimensionally periodic stack to achieve colour shifting. However, the current invention discloses nanoparticle self-assembly to give a 3-dimensionally periodic array of materials. The 3-dimensionally periodic arrays of materials are sintered to retain their structural integrity and are surface functionalized to enable to disperse in a variety of matrices. Colours are tuned by varying the size of the nanoparticles chosen.

Further, the invention can be described as a stack of opals. Opals are optionally made of polymeric materials or inorganic materials. The polymeric materials that comprise the opals according to the invention are selected from polymeric lattices, exemplified herein as in polystyrene, polymethylmethacrylate and such like. The inorganic materials in monodispersed particulate form with a size scale of 100-600 nm, exemplified herein are silica, titania and such like.

The optically variable products are prepared on a flat substrate. The substrates are selected from any flat material, preferably mica. The formed optically variable products are used as such. In one embodiment of the invention, the formed optically variable products are released from the flat substrate before dispersion into an ink formation. In another embodiment, the formed optically variable products are delaminated from the flat substrate before dispersion into an ink formation. Further they are surface modified to enable them to disperse in the ink by suitable surface treatment.

The technique of the current invention affords tunability of the optical properties by deforming the array. In an embodiment of the invention, the tunability is achieved by creating inverse opals: viz. the empty spaces in a periodic arrangement of spheres as obtained above is filled with another material, and the original spheres are removed by calcination or using solvent so as to create a periodic arrangement of air spheres within the material.

The process of preparation of the optically variable-product of the instant invention comprises the steps of:

a) preparing a dispersion of the polymeric material or inorganic material of particle size 50 to 2500 nm;
b) spraying the dispersion on a surface of controlled hydrophilicity to obtain an ordered assembly,
c) drying the dispersion to obtain the formation of close-packed iridescent layers of particles at room temperature,
d) determining the colour by the layer periodicity formed;
e) annealing the particle layer just below the glass transition of polymeric material to sinter the spheres and to freeze the periodic layer structure;
f) separating the layer by sonicating the coated substrate in a bath to obtain the optically variable product, wherein the colour is structural in character and
g) modifying the surface of the product by adsorption of polyelectrolytes, and chemical treatment to obtain optically variable product dispersible in solvents.

Surfaces of controlled hydrophilicity used for the dispersion are to wet the surface and it dries to form an assembly of particles.

Polymers with functionalizable groups are the materials chosen for the optically variable products of the instant invention.

In one embodiment, polyethylene imine is adsorbed on the surface to make the optically variable product hydrophobic, followed by reaction of the primary amine groups with alkyl- or aryl-aldehydes.

In another embodiment of the invention, a thin glass sheet is dipped into a dispersion of silica or polystyrene spheres. On pulling the substrate out, there is flow-induced organization of the spheres into an opaline array.

In another embodiment of the invention, the dispersion is deposited to form the assembled optically variable product, followed by infiltration of the voids by a polymer, instead of sintering. This resultant polymer-embedded photonic crystal is delaminated off the substrate and optionally surface modified. Optionally polymer is added to tune the particle-particle spacing, and therefore, colour.

The optically variable products of the invention as described herein are dispersed in solvents and coated on the currency notes, stamps, stamp papers, secure packaging materials, passports, stock certificates, identity cards and such documents to aid in the detection and prevention of counterfeiting. Further such products are formulated on the security thread of said documents that are to be detected for counterfeiting and prevented from counterfeiting. They are dispersed in the inks used to print the text matter on the product such as security numbers of such documents.

In an embodiment of the invention the optically variable products are used as such.

In another embodiment the optically variable products are optionally deposited on a substrate which is potentially to be detected for counterfeiting.

In yet another embodiment of the invention, the security product is a film on which the optically variable products of the invention are deposited. In another embodiment, such deposited optically variable products are preferably coated. The deposition of optically variable products on films may optionally use a binder or varnish.

For detecting, preventing counterfeiting, the optically variable product is coated, applied or introduced in the security document. The security document is viewed in different angles to observe the colour changes in the optically variable product.

### EXAMPLES

The present invention will be more specifically explained by following examples. However, the scope of the present invention is not limited to the scope of these examples below.

### Example 1

A dispersion of polystyrene (50 microliters of a 5%, weight/volume of polystyrene spheres in water, with a sphere diameter of 300 nm) is pipetted onto and dried at room temperature on a surface of controlled hydrophilicity obtained by cleaning a mica sheet using a basic piranha etch. On drying, the particles are close-packed to form an iridescent ordered assembly—the periodicity from 300 nm particles in the iridescent ordered assembly corresponds to the obtained green colour. The particle layer is annealed just below the glass transition (100° C. for polystyrene) so as to sinter the spheres and to freeze the periodic layer structure. This assembly is sonicated for 5 minutes in a bath type sonicator, to yield fragment aggregates which retain the particle order and therefore the iridescence. Finally obtained is, a dispersion of green optically variable product, wherein the colour is structural in character. (ONLY VISUAL OBSERVATION)

A 1 ml dispersion of the optically variable product is mixed with 1 ml of a 1 mg/ml solution of Polyethylene imine (PEI) with a molecular weight of 70000 g/mol. The PEI adsorbs on the surface of the optically variable product. Excess PEI is separated by centrifugation of the optically variable product (at 2000 g for 2 minutes) and washing with water.

The primary amine groups from the PEI on the surface of the optically variable product are reacted with acetaldehyde (or, in another example, with benzaldehyde). An excess of the aldehyde is added (1 ml aldehyde is added to 1 ml of the fragment dispersion) and the excess aldehyde is simply removed by centrifugation and washing. The surface treated optically variable products are now dispersible in organic solvents such as hexane and toluene.

### Example 2

A dispersion of silica (50 microliters of 5% weight/volume dispersion in water of silica spheres of size 200 nm) is pipetted onto and dried on a glass surface so as to obtain an assembly of spheres. On drying at room temperature, this assembly is observed to be iridescent. The spheres are sintered together by heating at 250° C. for 10 minutes, and the resulting structural optically variable product released from the surface by sonicating in a bath for 5 minutes.

The silica based product is surface functionalized by reaction with organosilanes-aminopropyltriethoxy silane, reacted from an ethanolic solution in excess.

### Example 3

A dispersion of silica is pipetted onto and dried on a surface so as to obtain an assembly of spheres. On drying, this assembly of spheres thus obtained is iridescent. The spheres are sintered together by heating, and the resulting structural optically variable product released from the surface by sonicating in a bath. The silica based product is surface functionalized by reaction with titanium isopropoxide. The optically variable product dispersion containing 100 mg of the optically variable product is dispersed in 1 ml of an ethanolic solution of 5% titanium isopropoxide and reacted at room temperature for 24 hours. The titanium isopropoxide hydrolyzes at the surface of the optically variable product and condenses to form a titania shell.

### Example 4

The polystyrene dispersion is prepared as an ordered assembly on the surface and sintered as described in Example 1. Tetraethylorthosilicate, is hydrolysed and condensed around the polystyrene spheres to generate a silica shell around the polystyrene dispersion. This is subsequently calcined generate inverse opaline structures of silica shells. These silica shells are modified by polyelectrolyte adsorption followed by an optional chemical treatment as described in Example 1.

### Example 5

The polystyrene dispersion is prepared as an ordered monolayer on the surface and sintered as described in Example 1. Tetraethylorthosilicate, is hydrolysed and condensed around the polystyrene spheres to generate a silica shell around the polystyrene dispersion. This is subsequently calcined to generate inverse opaline structures of silica shells. These silica shells are modified by polyelectrolyte adsorption followed by organosilane condensation on their surface as described in Example 2.

### Example 6

A dispersion of polystyrene (50 microliters of a 5%, weight/volume of polystyrene spheres in water, with a sphere diameter of 300 nm) is pipetted onto and dried at room temperature on a surface of controlled hydrophilicity obtained by cleaning a mica sheet using a basic piranha etch. On drying the particles are close-packed to form an iridescent ordered assembly—the periodicity from 300 nm particles in the iridescent ordered assembly corresponds to the obtained green colour. The particle layer is annealed just below the glass transition (100° C. for polystyrene) so as to sinter the spheres and to freeze the periodic layer structure. This assembly is sonicated for 5 minutes in a bath type sonicator, to yield fragment aggregates which retain the particle order and therefore the iridescence. Finally obtained is a dispersion of green optically variable product, wherein the colour is structural in character.

A 1 ml dispersion of the optically variable product is mixed with 1 ml of a 1 mg/ml solution of Polyethylene imine (PEI) with a molecular weight of 70000 g/mol. The PEI adsorbs on the surface of the optically variable product. Excess PEI is separated by centrifugation of the optically variable product (at 2000 g for 2 minutes) and washing with water.

The primary amine groups from the PEI on the surface of the optically variable product are reacted with benzaldehyde. An excess of the aldehyde is added (1 ml aldehyde is added to 1 ml of the fragment dispersion) and the excess aldehyde is simply removed by centrifugation and washing. The surface treated optically variable products are now dispersible in hexane.

### Example 7

A dispersion of polystyrene (50 microliters of a 5%, weight/volume of polystyrene spheres in water, with a sphere diameter of 300 nm) is pipetted onto and dried at room temperature on a surface of controlled hydrophilicity obtained by cleaning a mica sheet using a basic piranha etch. On drying at room temperature, the particles are close-packed to form an iridescent ordered assembly—the periodicity from 300 nm particles in the iridescent ordered assembly corresponds to the obtained green colour. The particle layer is annealed just below the glass transition (100° C. for polystyrene) so as to sinter the spheres and to freeze the periodic layer structure. This assembly is sonicated for 5 minutes in a bath type sonicator, to yield fragment aggregates which retain the particle order and therefore the iridescence. Finally obtained is a dispersion of green optically variable product, wherein the colour is structural in character.

A 1 ml dispersion of the optically variable product is mixed with 1 ml of a 1 mg/ml solution of Polyethylene imine (PEI) with a molecular weight of 70000 g/mol. The PEI adsorbs on the surface of the optically variable product. Excess PEI is separated by centrifugation of the optically variable product (at 2000 g for 2 minutes) and washing with water.

The primary amine groups from the PEI on the surface of the optically variable product are reacted with benzaldehyde. An excess of the aldehyde is added (1 ml aldehyde is added to 1 ml of the fragment dispersion) and the excess aldehyde is simply removed by centrifugation and washing. The surface treated optically variable products are now dispersible in and toluene.

### Example 8

A thin glass sheet is used as substrate to dip into a dispersion of silica spheres. The surface of the glass sheet is prepared by etching it in a basic piranha solution rendering it hydrophilic. Subsequently, the glass sheet is dipped in the aqueous dispersion of silica spheres and is withdrawn at a rate of 0.1 mm/hour using a stepper motor. A thin film of the dispersion adheres to the surface of the glass and the water from this evaporates leaving behind an opaline array on the glass surface. The opaline array is dried overnight at room temperature and is then sintered at 200° C. for 6 hours.

On pulling the substrate out, there is flow-induced organization of the spheres into an opaline array. The opaline assembly is sintered onto the substrate by heating and this assembly is surface treated. This is used as an optically variable product by breaking up the substrate and dispersing into the ink formulation.

### ADVANTAGES OF THE INVENTION

The present invention provides composition and method for easy identification of counterfeiting.
The method of identification described in the present invention is a simple as well as a visual means to facilitate the process of identification of counterfeiting.

1. Surface modified optically variable product for detecting/preventing counterfeiting comprising a nanoparticle self assembly of a polymer or an inorganic material wherein said optically variable product is in the form of an ink or coating in a security document.

2. Surface modified optically variable product of claim 1, wherein the nanoparticle self assembly comprises a polymer material is selected from the group consisting of polystyrene and polymethylmethacrylate.

3. Surface modified optically variable product of claim 1, wherein the size of the polymer or an inorganic material varies in the range of 50 to 2500 nm.

4. Surface modified optically variable product as of claim 1, wherein polymeric material is characterized by having functionalizable groups.

5. A process for the preparation of optically variable product useful in detection/prevention of counterfeiting comprising:
i. preparing a dispersion of the polymeric material or inorganic material of particle size 50 to 2500 nm;
ii. spraying the dispersion on a surface of controlled hydrophilicity to obtain a monolayer of spheres;
iii. drying the dispersion at room temperature to obtain the formation of close-packed iridescent layers of particles and determining the colour by the layer periodicity formed;
iv. annealing the particle layer just below the glass transition of polymeric material to sinter the spheres and to freeze the periodic layer structure;
v. separating the layer as obtained in step (iv) by sonicating the coated substrate in a bath to obtain the optically variable product, wherein the colour is structural in character;
vi. modifying the surface of the product by adsorption of polyelectrolyte and by chemical treatment to obtain optically variable product;
vii. dispersing the optically variable product in organic solvents and coating on security documents to aid in detection of counterfeiting of security documents.

6. A process as claimed in claim 5, wherein the surface of controlled hydrophilicity is selected from a flat substrate.

7. A process of claim 5, wherein the polyelectrolyte used is polyethylene imine to make the optically variable product hydrophobic.

8. A process of claim 5, wherein aldehyde and organo silane are used for chemical treatment.

9. A process of claim 8, wherein the aldehyde is selected from the group consisting of aliphatic aldehyde and aromatic aldehyde.

10. A process of claim 8, wherein the organo silane used is aminopropyltriethoxysilane.

11. A process of claim 5, wherein organic solvent is selected from the group consisting of hexane and toluene.

12. A process of claim 5, wherein the said optically variable product is in the form of ink, which is formulated in the security thread of security document.

13. A process of claim 5, wherein the said optically variable product is tuned to get all the colors in the visible spectrum.

14. Surface modified optically variable product of claim 1, wherein the security document is selected from the group consisting currency notes, stamps, stamp papers, secure packaging materials, passports, stock certificates and identity cards.

15. A process as claimed in claim 6, wherein the flat substrate is mica.

16. A process as claimed in claim 9, wherein the aliphatic aldehyde is acetaldehyde.

17. A process as claimed in claim 9, wherein the aromatic aldehyde is benzaldehyde.

18. Surface modified optically variable product of claim 1, wherein the nanoparticle self assembly comprises an inorganic material is selected from the group consisting of silica and titania.
